(19) United States
(12) Patent Application Publication
(10) Pub. No.: US 2003/0173204 A1
(43) Pub. Date: Sep. 18, 2003

(54) Obtaining fresh water and salt from the marine water and distillation system

(76) Inventor: Gines Sanchez Gomez, Mostoles (Madrid) (ES)

Correspondence Address: Gines SANCHEZ GOMEZ, Calle Cervanters, 1, 7, B, Mostoles (Madrid), 28932, ES

(21) Appl. No.: 10/374,924

(22) Filed: Feb. 24, 2003

(30) Foreign Application Priority Data
Mar. 18, 2002 (ES) P200200733

(51) Int. Cl. B01D 3/10; B01D 3/42; C02F 1/04

(52) U.S. Cl. 202/83; 203/11; 159/47.1; 159/44; 159/903; 159/DIG. 16; 202/160; 202/205; 202/234; 203/1; 203/2; 203/3; 203/10; 203/91; 203/DIG. 1; 203/71; 203/DIG. 4; 203/DIG. 18; 203/DIG. 20

(57) ABSTRACT

A distillate system, especially of the sea water, by using the sun as heat source and the sea water as cold source, falling the work pressure to the boiling point of the sea water between the temperature generated by the sun and the temperature of the sea water. The sea water and the fresh water are entered/removed to/from the distillation system at the same time, by compensating the pressure differences.

### CROSS-REFERENCE TO RELATED APPLICATIONS

The present invention is based on the Spanish application of patent no. P200200733, dated Mar. 18, 2002, that is priority. Following patents are related with the present invention:

U.S. Pat. No. 6,494,995. A floating solar cell, being created a partial vacuum in the solar cell.

U.S. Pat. No. 6,391,162. A desalination system utilizing solar energy provided with a solar heat collector, a heat exchanger, a condenser and a raw water tank.

### BACKGROUND OF THE INVENTION

They are well known the vacuum distillation systems. Regarding the distillation of sea water, said vacuum is between 0.6 and 0.9 at. of work pressure, because lower pressures mean to spend a lot of energy for remove out the fresh water from the distillation apparatus.

The previous implies that the work temperature is far regarding the possibilities of the solar heat. So, to boil the sea water using the sun heat, the work pressure would be between the 0.03 and the 0.07 at.

### BRIEF SUMMARY OF THE INVENTION

This invention proposes a system that allows very low work pressures and by this, the efficient use of the solar heat, or another heat sources of low temperature, according with the following.

The sea water is evaporated into an evaporation tank by the solar heat. The vapor is condensed into a condensation tank by the relatively cool sea water. Said tanks being connected by a vapor conduit. The set of the tanks and the conduit being isolated from the external atmosfhere. The sea water would boil at the temperature of the evaporation tank and would condensate at the temperature of the sea water. By this the work pressure is lowered by a vacuum pump.

To remove the fresh water from the condensation tank, a extraction pump is provided. Said pump would spend a lot of energy because the fresh water goes from a pressure of 0.05 at. (by example), to a pressure of 1 at.

But, when the sea water enter, the sea water goes from a pressure of 1 at. to a pressure of 0.05 at. If said sea water is drove from the sea to the evaporation tank through a turbine with a capacity similar to the extraction pump, and the shafts of the turbine and the extraction pump are connected, an important amount of energy could be saved.

Naturally the system is suitable to be applied to another distillation system.

### BRIEF DESCRIPTION OF THE FIGURES

FIG. 1. A general distillation system.

FIG. 2. The distillation system with several distilled products.

FIG. 3. The distillation system to obtain fresh water and salt from the sea water.

FIG. 4. Transversal view of an evaporation tank.

FIG. 5. Transversal view of an evaporation tank for obtain only fresh water.

FIG. 6. Travenrsal view of two evaporation tanks to obtain different salts.

FIG. 7. The distillation system on a floating platform.

FIG. 8. Transversal view of an evaporation tank with a container for the salt.

### DETAILED DESCRIPTION OF THE INVENTION

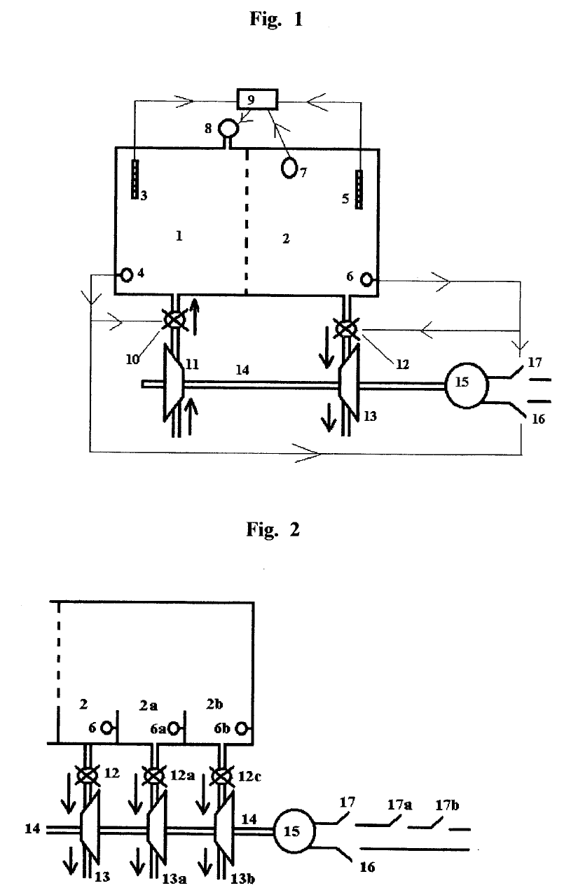

FIG. 1 illustrates a very general distillation system with a evaporation zone 1 and a condensation zone 2. The zone 1 comprises a first thermometer 3, and a first capacity sensor 4, while the zone 2 comprises a second thermometer 5 and a second capacity sensor 6. The whole evaporation system has a nanometer 7, a vacuum pump 8 and a control unit 9 of said vacuum pump.

The evaporation system is fed through a valve 10 and a turbine 11, controlled by the first capacity sensor 4, being emptied through a valve 12 and a extraction pump 13, controlled by the second capacity sensor 6. The turbine and the extraction pump having a common shaft 14 and a motor 15 (by example electric). The control of the turbine and the extraction pump is through the motor 15, said motor is fed by a first switch 16, controlled by the first capacity sensor 4, and a second switch 17, controlled by the second capacity sensor 6.

The control unit of the vacuum pump activates the vacuum pump while the internal pressure of the system is upper the desirable value according the reading of the first and second thermometers, and the nanometer.

FIG. 2. If there are several distilled products 2, 2a, 2b, they must be the same number of extraction pumps 13, 13a, 13bas distilled products. All the extraction pump must be assembled on the same shaft 14 and the relative volume between the pumps must be the same that its connected distilled products. In addition, for each additional extraction pump it must have one additional capacity sensor 6, 6a, 6b in the condensation zone and one additional switch in series to feed the electric motor 17, 17a, 17b.

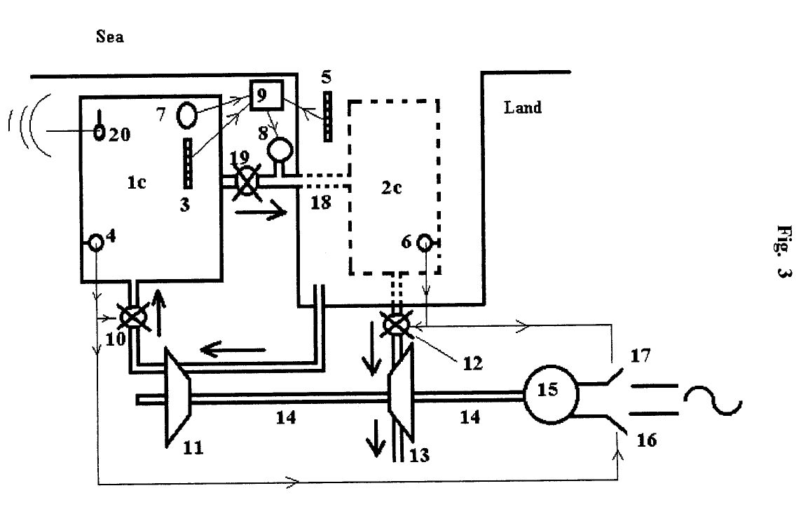

FIG. 3 shows a sea water distillation. The evaporation zone is a evaporation tank placed at the sun 1c and fed by the sea water, while the condensation zone is a submerged condensation tank 2c, its walls being thermally conductors. The capacity sensor 4 is a buoy that activates the valve 10 and the switch 16 when the same falls a prefixed value, until said buoy raises another prefixed value. The capacity sensor 6 is a buoy that activates the valve 12 and the switch 17 when the same raises a prefixed value, until said buoy falls another prefixed value.

The capacity of the turbine 11 and the extraction pump 13 are substantially the same.

A vapor conduit 18 links the evaporation tank 1c and the condensation tank 2c, being the vacuum pump 8 on said conduit, and having said conduit a vapor valve 19. Said vapor valve 19 can be useful when the evaporation tank would be emptied, because closing said vapor valve, the vacuum of the condensation tank is preserved.

Furthermore, the FIG. 3 also shows a densimeter 20 for control purposes, by example being connected to an alarm.

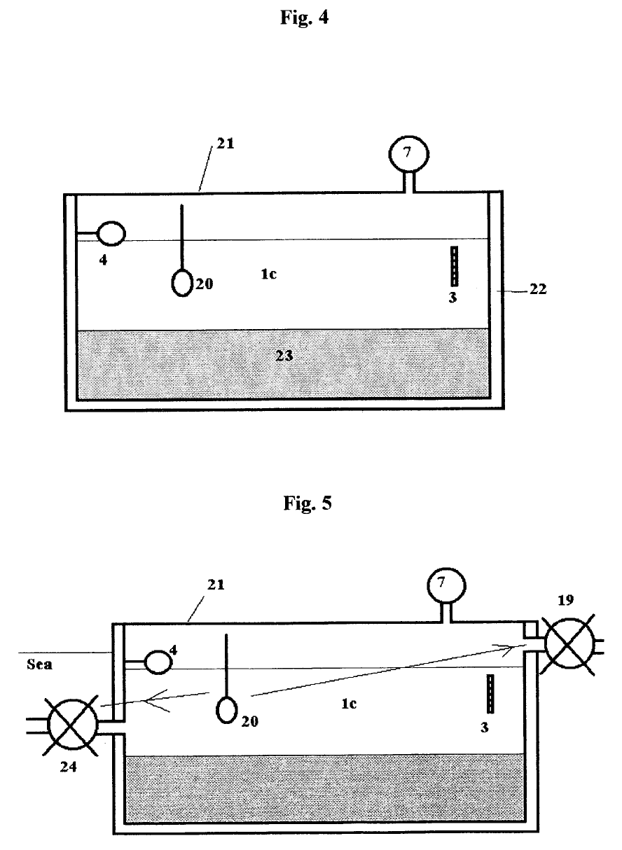

FIG. 4 represents a transversal view of the evaporation tank 1c, showing a transparent cover 21, isolated walls 22 and the precipitated salt 23.

FIG. 5 illustrated the evaporation tank 1c when the salt is not desired. The densimeter 20 controls the vapor valve 19 and a marine valve 24 which connects the evaporation tank with the sea. When the densimeter 20 raises a prefixed value closes the valve 19 and opens said marine valve 24, then the sea water penetrates into the condensation tank, until a prefixed amount of salt is dissolved. Then the marine valve 24 is closed and the vapor valve 19 is opened.

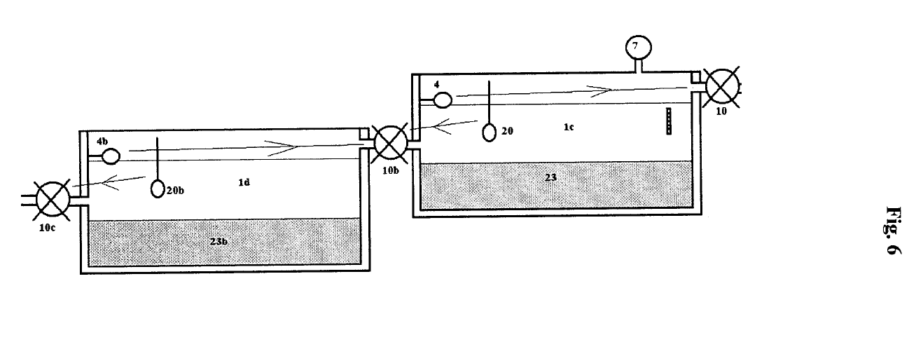

FIG. 6. It is possible to obtain several salt types by putting several consecutive evaporation tanks. By this, a second evaporation tank is connected with the first evaporation tank through a second input valve 10b, the second evaporation tank with the third with a third valve 10c, . . .

The second input valve 10b is controlled at the same time by the densimeter of the first evaporation tank 20 and the buoy of the second evaporation tank 4b, while the third input valve l0c is controlled by the densimeter of the second evaporation tank 20b and the buoy of the third evaporation tank.

Then, each input valve is opened when its densimeter and its buoy reach a prefixed value.

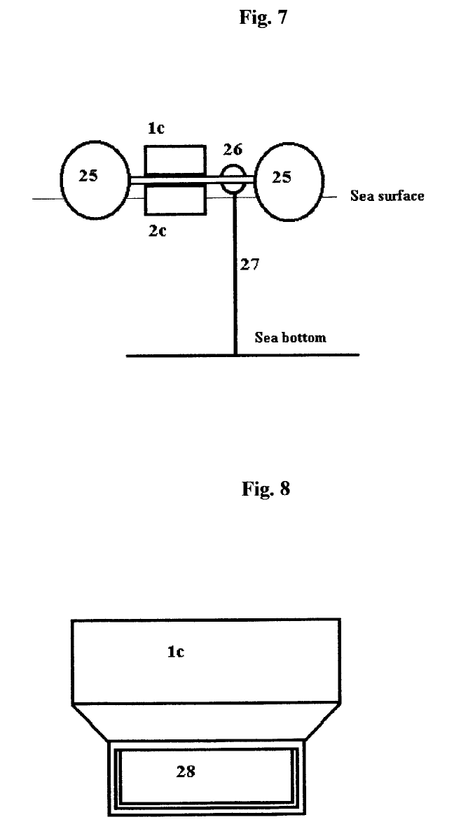

FIG. 7 represents the distillation sea water system assembled to a marine platform, showing the evaporation tank 1c and the condensation tank 2c, a floating 25, a device to pick up power from the sea waves 26 and a anchorage 27 to the sea bottom.

FIG. 8 shows the evaporation tank 1c with a mobile container 28 to remove the salt.

Regarding this invention, a turbine is a device which transforms pressure differences in mechanical energy and a pump is a device which transforms mechanical energy in pressure differences. There are a lot of turbine and pump types, but the set of turbine—pump—common shaft—motor shaft—motor must be compatible. So, they are possible the following configurations:

a rotating turbine, a rotating pump, a rotating common shaft, a rotating motor shaft and a rotating motor,

a piston turbine, a piston pump, a oscillation common shaft, a rod-crank mechanism and a rotating motor,

a rotating turbine, a rotating pump, a rotating common shaft, a rod-crank mechanism and a piston motor,

a piston turbine, a rotating pump, the common shaft being a rod-crank mechanism, a rotating motor shaft and a rotating motor,

The previous paragraph are not represented because all said devices are well known in the art.

I claim for:

1. A vacuum distillation method for low difference of temperature between the evaporation zone and the condensation zone characterized in that
the work pressure is lowered until the boiling of the liquid to distillate, according the temperature difference between the evaporation zone and the condensation zone,
the product to distillate and the distilled products are entered/removed to/from the distillation system at the same time, by compensating the pressure differences.

2. The method for the vacuum distillation of the claim 1, characterized in that the temperature difference between the evaporation zone and the condensation zone are obtained from natural sources of heat and cold.

3. The method for the vacuum distillation of the claims 1 and 2, characterized in that the product to distillate is sea water, the distilled product is fresh water, the source of heat is the sun, the source of cold is the sea water and the salt is periodically removed.

4. The method for the distillation of the sea water of the claim 3 to obtain fresh water, characterized in that the salt is removed for the input and output of the sea water into the system.

5. The method for the distillation of the sea water of the claim 3 to obtain salt, characterized in that the fresh water is removed from the system to the sea.

6. A vacuum distillation system for low difference of temperature between the evaporation zone and the condensation zone comprising:
a first thermometer and a first capacity sensor into the evaporation zone,
a second thermometer and a second or subsequent capacity sensors into the condensation zone,
a nanometer,
a vacuum pump, being said vacuum pump controlled by a control unit, according the measures of the first thermometer, the second thermometer and the nanometer,
a input valve controlled by the first capacity sensor,
a turbine to feed the evaporation zone through the input valve,
one o more output valves controlled by the second or subsequent capacity sensors,
one or more extraction pumps to remove the distillation products from the condensation zone through the output valves,
the turbine and the extraction pumps, being assembled on a common shaft or transmission device,
being the turbine a device which transforms pressure differences in mechanical energy, and each extraction pump a device which transforms mechanical energy in pressure differences,
the relative volume between the turbine and the pumps is the same that its connected products,
a motor to move the turbine and the extraction pumps through the common shaft,
said motor fed through two o more switches in series, each switch controlled by each capacity sensors.

7. The vacuum distillation system for separate the salt and the fresh water from the sea water, being the sun the source of heat and being the sea water the source of cold, according the claim 6, characterized in that
the evaporation zone is a evaporation tank, with a transparent cover, and isolated walls and floor,
the condensation zone is a condensation tank, being submerged and its walls being thermally conductors,
a vapor conduit with a vapor valve linking the evaporation tank and the condensation tank,
the vacuum pump is located on said vapor conduit between the vapor pump and the condensation tank,
the capacity sensor of the evaporation zone is a first buoy,
the capacity sensor of the condensation zone is a second buoy,
the first buoy controls the input valve and one switch of the motor when said first buoy falls a prefixed value, until said first buoy raises another prefixed value,
the second buoy controls the output valve and another switch of the motor when said second buoy raises a prefixed value, until said second buoy falls another prefixed value,
a densimeter into the evaporation zone.

8. The vacuum distillation system for obtain only fresh water from the sea water, according the claim 7, characterized in that
the evaporation tank has a marine valve,
said valve and the vapor valve are controlled by the densimeter,
when the densimeter raises a prefixed value closes the vapor valve and opens the marine valve, penetrating the sea water into the condensation tank,
when a prefixed amount of salt is dissolved in the sea water, then the marine valve is closed and the vapor valve is opened.

9. The vacuum distillation system for obtain only salts from the sea water, according the claim 7, characterized in that
a second evaporation tank is connected with the evaporation tank through a second input valve, the second evaporation tank with a third with a third valve, and consecutivily,
each input valve being controlled at the same time by its buoy and the densimeter of the previous evaporation tank.

10. The vacuum distillation system according the claim 7, characterized in that the same is assembled to a marine platform, with a device to pick up power from the sea waves.

11. The vacuum distillation system according the claim 7, characterized in that the evaporation tank is mobile.

12. The vacuum distillation system according the claim 7, characterized in that the evaporation tank has a mobile container to remove the salt.
